(19) United States
(12) Patent Application Publication
(10) Pub. No.: US 2016/0083294 A1
(43) Pub. Date: Mar. 24, 2016

(54) THIN FILM COLOR COATING METHOD FOR HARD-TO-DYE YARN

(71) Applicant: SOFOS Co., Ltd., Seongju-gun (KR)

(72) Inventors: Sung-Woo JIN, Daegu (KR); Kyung-Don KIM, Daegu (KR); Gwang-Hoe KOO, Daejeon (KR); Deuk-Won YUN, Daegu (KR)

(73) Assignee: SOFOS CO., LTD., Seongju-gun (KR)

(21) Appl. No.: 14/707,964

(22) Filed: May 8, 2015

(30) Foreign Application Priority Data
Sep. 18, 2014 (KR) 10-2014-0124413

(51) Int. Cl. C03C 25/28; C03C 25/62; D06M 13/203; D06M 10/00; D06M 13/188

(52) U.S. Cl. CPC C03C 25/285; D06M 10/001; D06M 13/188; D06M 13/203; C03C 25/6226; D06M 2101/20

(57) ABSTRACT

Disclosed is a method for hardening an ultraviolet ray hardening type coating liquid after a thin film coating layer is formed by impregnating a yarn formed of hard-to-dye yarns in the ultraviolet ray hardening liquid, while providing an environment friendly manufacturing method wherein about 70% of an energy may be saved as compared with a conventional thermosetting method, and carbon dioxide from a combustion is not produced, and a water washing process may be omitted with the aid of a high degree of conversion, while providing a good adhesion strength and various performances by dispersing various functional substances.

### TECHNICAL FIELD

The present invention relates to a thin film color coating method for an industrial fiber on which it is hard to form colors, using an ultraviolet ray, and in particular to an energy-saving and environment friendly yarn coating and manufacturing method.

### BACKGROUND ART

As worries on energy depletion and concerns on environment change increase throughout the world, the development on alternative energy and the way of saving energy are necessarily reflected in the nation's policy, and there is an effort to reduce any harmful factors on the natural environment. For the harsh environment-related regulations in domestic and oversea countries, the wet process for the dyeing and process consumes about 70% of energy in the whole textile industry, which may result in a lot of load on the certified emission reductions in the textile industry.

In the process for a color formation on fiber, there are firstly a crude liquid coloring process wherein a dye is added into a raw material during the manufacturing of yarn, secondarily a dyeing process wherein the dyeing is performed using a dye in a yarn or fiber state, and thirdly a coating process wherein the preparation is made with pigment or dye. Speaking in terms of chemical, a fiber is a polymer formed of huge chemical molecules. There is a common dyeing process wherein a dye penetrates into a non-crystal region, so reaction is performed.

At this time, chemicals, for example, leveling agent, additive, acid or alkali regulation agent may be added, except for dyes. Here, color formation may be easy in case where there is heat high enough for the dye to easily penetrate.

In case of a hard-to-dye fiber on which it is hard to form color by a dyeing process, color is formed by the crude liquid coloring process wherein dye is added into a fiber material, however such a process may be impossible when forming various colors. Since a dye dispersion in a fiber polymer and a fiber manufacturing process are hard, cost is high, so there are many limitations for industrialization. The coating process, which is a post-process, had advantages in low cost and various color formation, however friction fastness is very poor because of a low adhering force between fiber and coating liquid, and high temperature heat due to a heat melting of a resin or an impregnation of a low viscosity resin and a thermosetting method should be used, thus causing many problems during the process, which may result in a low production speed, so mass production is hard to achieve.

The hard-to-dye fiber represents a fiber on which it is hard to form color in such a way to use commercially available dyes and other additives and a heated water-based dyeing method, the problems of which occur due to the lack of the penetration and durability of dyes since the fiber polymer is formed of strong polymer chains or is formed in a chemical structure which cannot react with dyes. As these fibers, there are polyethylene (PE) and polypropylene (PP) fibers, and as a high performance industrial fiber, there are glass fiber, ultra high molecular weight polyethylene (UHMWPE), aramid fiber, carbon fiber, polyimide (PI), polybenzoxazole (PBO), polybenzimidazole (FBI), etc. which belong to a high strength, high heat resistance fiber, so such fibers are generally used for the purpose of industry rather than the purpose of clothes due to the above-mentioned problems.

In case of the glass fiber, the physical properties of the targeted product may change in accordance with components. If dye or pigment is mixed in silica, which is a main ingredient, during the crude liquid coloring process for the sake of color formation, color formation may be impossible since it is impossible to estimate any change in a product's physical property. In the PE, PP fibers which are polyolefin fibers, there is not any functional group which may react with dyes, so color formation is hard. In case of a high performance fiber, for example, a UHMWPE, aramid, PBO, PBI, etc., since a polymer structure and a non-crystal region are minimized, the penetration of dyes is not easy, so color formation becomes harder. In addition, since carbon fiber is formed of only carbons in structure through a carbonization process, the fiber itself is a deep shade black, so color formation is hard.

For the UHMWPE among the hard-to-dye fibers, a new dye has been developed since a color formation was hard with commercially available dyes. More specifically, the color formation can be possible through a dyeing process wherein a superhydrophobic dye is synthesized by substituting an alkyl group, which is similar with a fiber polymer, with a base component of a conventionally available dispersion dye.

However, any change in the physical property of the fiber itself may be caused during the dyeing process wherein a high temperature heat water is used because of a low heat resistance of the fiber itself, and the mass production and commercialization of dyes are impossible, so the above newly developed dye may not apply to other hard-to-dye fibers, thus making hard the further development thereof. Therefore, it is necessary to invent a new color formation process with respect to the hard-to-dye fiber on which it is hard to form dyes through the crude liquid coloring process or the dyeing process which are the conventional color formation processes. The color formation should be secured in such a way that the change of natural physical property of the fiber is small, and commercialization is easy, and cost is low.

The coating process in the color formation process, as mentioned earlier, may be characterized in that a color coating may apply to fiber using an ultraviolet ray-based hardening so as to improve the durability of the coated layer against friction and the productivity. The ultraviolet ray-based hardening may be finished within seconds or tens of minutes until liquid resin is fully hardened, thus improving the productivity, while improving fastness against friction thanks to the formation of smooth surface.

### PRIOR ART DOCUMENTS

### Patent Documents

(Patent Document 1) Korean Patent Publication No. 10-2011-0101755 (published on Sep. 16, 2011)
(Patent Document 2) Korean Patent Publication No. 10-1383087 (published on Apr. 8, 2014)

### DISCLOSURE OF THE INVENTION

Accordingly, it is an object of the present invention to provide an environment friendly method wherein about 70% of energy saving as compared with a conventional thermosetting yarn coating method may be secured, and carbon dioxide due to combustion does not irradiate, and a water washing process may be omitted thanks to a high degree of conversion.

It is another object of the present invention to provide a method for a color formation on a hard-to-dye fiber using a thin color coating while providing a good adhesive strength.

To achieve the above objects, there is provided a thin film color coating method for a hard-to-dye fiber yarn, which may include preparing an ultraviolet ray hardening type coating liquid by mixing 0.9˜10% by weight of dye, 30˜89% by weight of ultraviolet ray hardening type monomer, 10˜40% by weight of ultraviolet ray hardening type oligomer and 0.1˜20% by weight of photo initiator; impregnating the hard-to-dye fiber yarn in the ultraviolet ray hardening type coating liquid; forming a thin film coating layer on the surface of the hard-to-dye fiber yarn by passing it through compression rollers with a constant pressure; and hardening the ultraviolet ray hardening type coating liquid by irradiating an ultraviolet ray of a wavelength range of 260˜395 nm in such a way to move the coated hard-to-dye fiber yarn in the vertical direction from the ground.

The exemplary embodiment of the present invention will be described in detail.

The thin film color coating method for a hard-to-dye fiber according to the present invention is directed to a way wherein a yarn formed of hard-to-dye fibers is impregnated in an ultraviolet ray hardening type coating liquid, thus forming a thin film coating layer, and the ultraviolet ray hardening type coating liquid is hardened, and in more particular, the present invention is directed to a method for manufacturing a hard-to-dye fiber wherein colors may be formed in such a way that a dye used for color formation and an ultraviolet ray hardening type resin are mixed to a predetermined concentration, and an ultraviolet ray is irradiated, and the mixed liquid is hardened, thus forming colors.

The hard-to-dye yarn which is the target of the thin film color coating of the present invention may be any one selected among glass fiber yarn, polyethylene (PE) fiber yarn, polypropylene (PP) fiber yarn, ultra high molecular weight polyethylene (UHMWPE) fiber yarn, aramid fiber yarn, carbon fiber yarn, polyimide (PI) fiber yarn, polybenzoxazole (PBO) fiber yarn, and polybenzimidazole (PBI) fiber yarn. These fiber yarns are hard to form colors using conventional commercially available dyes and other additives and a dyeing process based on heat water.

In the present invention, the ultraviolet ray hardening type coating liquid used for coating a hard-to-dye fiber yarn may use an ultraviolet ray hardening type coating liquid wherein 0.9˜10% by weight of dye, 30˜89% by weight of ultraviolet ray hardening type monomer, 10˜40% by weight of ultraviolet ray hardening type oligomer and 0.1˜10% by weight of photo initiator are mixed.

It is preferred that the dye among the ultraviolet ray hardening type coating liquid is an organic dye with resistance to discoloration from ultraviolet ray and may be any one among Azo-dyes, naphthols, phthalocyanine, etc.

In general, the resin used for an ultraviolet ray hardening type coating liquid is formed of oligomer and monomer of acrylate. The monomer and oligomer may change as follows in accordance with the characteristics of the surface of the hard-to-dye fiber.

It is preferred that the ultraviolet ray hardening type monomer among the ultraviolet ray hardening type coating liquid may be formed of one or more than one selected from the group consisting of methyl methacrylate, Isobonyl acrylate, Tetrahydrofurfuryl acrylate, 2-hydroxyethyl acrylate, 2-hydroxyethyl methacrylate, 2-hydroxypropyl acrylate, n-butyl acrylate, Hexanediol diacrylate, Etoxy Etoxy ethylacrylate, and Octadecyl acrylate.

The ultraviolet ray hardening type oligomer among the ultraviolet ray hardening type coating liquid may use one or more than one oligomer selected from the group consisting of polyurethane acrylate, epoxy acrylate, unsaturated polyester acrylate, vinyl acrylate, polyvinyl butyral and polymethylmethacrylate. The reason why various monomer and oligomer are used is that it needs to manufacture a mixed liquid which has a good adhesive strength with the coating layer and the fiber, and it needs to mix a coating liquid which has a physical property similar with the characteristic of the surface of the fiber. It is preferred that the photo initiator among the ultraviolet ray hardening type coating liquid uses any one selected from the group consisting of benzophenone, Irgacure 184(1-Hydroxy-cyclohexyl-phenyl ketone), Irgacure 1173(2-Hydroxy-2-methyl-1-phenyl-1-propanone), Irgacure 907(2-methyl-1-[4-(methylthio)phenyl]-2-(4-mor-pholinyl)-1-propanone), Darocure TPO(Diphenyl(2,4,6-trimethylbenzoyl)phosphine oxide), thus matching with the ultraviolet ray radiation wavelength.

The hard-to-dye fiber yarn is impregnated in the thusly prepared ultraviolet ray hardening type coating liquid and is passed through a compression roller with a predetermined pressure, thus forming a thin coating layer on the surface of the hard-to-dye fiber yarn. The compression roller is provided so as to compress and form a coating layer with a predetermined thickness on the surface of the fiber yarn using the mixed liquid, and it is possible to estimate a weaving possibility of a color-coated yarn based on the thickness of the coating layer. The compression roller unit for forming a coating layer with a predetermined thickness should be made of a rubber or silicon material flexible enough to adjust the pressure. The pressure adjustment of the compression roller may be performed with a device which can adjust the thickness of the coating layer on the surface of the fiber yarn. If compressed with a higher pressure, a too thin film may be formed or a partially non-coated portion may occur, thus degrading the uniformity in colors. If compressed with a lower pressure, since a coating layer may become thicker, the uniformity of the coating layer may be degraded after the hardening with the aid of the flow of the liquefied coating liquid, so the weaving work using the coating yarn may be impossible.

Thereafter, an ultraviolet ray with a wavelength range of 260˜395 nm is irradiated while the coated hard-to-dye fiber yarn moves in the vertical direction from the ground, thus hardening the ultraviolet ray hardening type coating liquid. Here, it is preferred that the ultraviolet ray irradiation is performed using a metal halide lamp which is formed by adding, to a mercury lamp, one or more than one selected from the group consisting of Fe, Ga and Mg and an ultraviolet ray LED which can irradiate an ultraviolet ray of a longest wavelength (395 nm), so it is possible to improve productivity since an ultraviolet ray of a wavelength longer than a mercury lamp can be irradiated, thus finishing the hardening within seconds to minutes. The ultraviolet ray LED may easily apply to a fiber material which is sensitive to heat because it is possible to harden at a room temperature of 20˜30° C. during the irradiation. In addition, the infrared ray drying process may be performed by installing an infrared ray drying unit before or after the ultraviolet ray irradiation process, which aims to improve the hardness by drying the contained moisture or through the dehydration of moisture in case where water soluble or water dispersion mixing liquid is used.

The ultraviolet ray hardening unit should move from the group in the vertical direction in order for the coated mixing liquid to keep a thin film with a predetermined thickness after the impregnation is performed and the compression roller has moved. In case where the system is installed in the horizontal direction with respect to the ground, it is impossible to form a uniform thin film coating layer since the liquefied mixing liquid has a flowability in the vertical direction in terms of the proceeding direction of coating due to the gravity.

In the present invention, it is preferred that the process is performed in the vertical direction from the ground from the impregnation of the coating liquid of the fiber yarn to the ultraviolet ray irradiation process so that the coated mixing liquid can form into a thin film with a predetermined uniform thickness after the impregnation and the compression roller operation. If the process is designed to be performed in the horizontal direction with respect to the ground or at a predetermined angle, a circular dome shape formation phenomenon may occur along the yarn since the liquefied mixing liquid has a flowability in the vertical direction in terms of the proceeding direction of coating due to the gravity, for which a uniform thin film coating layer may not be formed, so it is impossible to weave into a fabric which may be used for a specific purpose.

### INDUSTRIAL EFFECTS

According to the present invention, there is provided an environment friendly method wherein about 70% of energy saving as compared with a conventional thermosetting yarn coating method may be secured, and carbon dioxide due to combustion does not irradiate, and a water washing process may be omitted thanks to a high degree of conversion, and there is provided a method for a color formation on a hard-to-dye fiber using a thin color coating while providing a good adhesive strength.

### BRIEF DESCRIPTION OF THE DRAWINGS

The patent or application file contains at least one color drawing. Copies of this patent or patent application publication with color drawing will be provided by the USPTO upon request and payment of the necessary fee.

The present invention will become better understood with reference to the accompanying drawings which are given only by way of illustration and thus are not limitative of the present invention, wherein;

FIG. 1 is a photo showing a coating-completed hard-to-dye fiber according to the present invention.

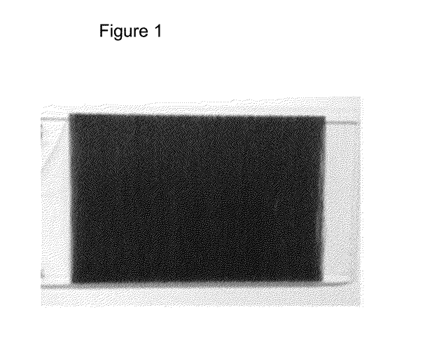

### MODES FOR CARRYING OUT THE INVENTION

The non-limited exemplary embodiments of the thin film color coating method for a hard-to-dye fiber according to the present invention will be described.

### Embodiment 1

An ultraviolet ray hardening type coating liquid is prepared, wherein 8% by weight of phthalocyanine organic dye (blue), 50% by weight of Methyl methacrylate monomer, 5% by weight of Etoxy Etoxy ethylacrylate monomer, 2% by weight of Hexanediol diacrylate monomer, 5% by weight of Tetrahydrofurfuryl acrylate monomer, 20% by weight of Polyvivyl butyral, 5% by weight of Benzophenone as photo initiator, 3% by weight of, Irgacure 1173 and 2% by weight of Darocure TPO are mixed.

Thereafter, an ultra high molecular weight polyethylene, which is a hard-to-dye fiber, is moved to the impregnation unit which accommodates the coating liquid, and the coating liquid is coated by a predetermined amount, and the coated coating liquid is compressed at a pressure of 1 MPa by two compression rollers, thus forming a thin film coating layer, and an ultraviolet ray of a wavelength range of 260˜395 nm is irradiated in the vertical direction from the ground, thus hardening the liquefied coating liquid through the photo hardening, and the formed yarn is wound by a rewinder unit in a shape of bunch, thus finishing the process. A result of the physical property test of the thin film color coating of an ultra high molecular weight polyethylene, which is a coating-completed hard-to-dye fiber is as follows.

TABLE 1

| Evaluation Items | Units | Embodiment 1 | Evaluation Method |
|---|---|---|---|
| Rate of change in | % | +0.5 | ASTM D 5034 |
| tensile strength | | | |
| Color Intensity | Total K/S | 258 | spectrophotometer |
| Deep coloration | ΔL | 39 | spectrophotometer |
| Sunshine fastness | Class | 4-5 | KS K ISO 105-C06 |
| Friction fastness | Class | 3-4 | KS K 0650 |
| Washing fastness | Class | 4 | KS K ISO 105-B02 |
| Water fastness | Class | 4-5 | KS K ISO 105-E01 |

What is claimed is:

1. A thin film color coating method for a hard-to-dye fiber yarn, comprising:
preparing an ultraviolet ray hardening type coating liquid by mixing 0.9˜10% by weight of dye, 30˜89% by weight of ultraviolet ray hardening type monomer, 10˜40% by weight of ultraviolet ray hardening type oligomer and 0.1˜20% by weight of photo initiator;
impregnating the hard-to-dye fiber yarn in the ultraviolet ray hardening type coating liquid;
forming a thin film coating layer on the surface of the hard-to-dye fiber yarn by passing it through compression rollers with a constant pressure; and
hardening the ultraviolet ray hardening type coating liquid by irradiating an ultraviolet ray of a wavelength range of 260˜395 nm in such a way to move the coated hard-to-dye fiber yarn in the vertical direction from the ground.

2. The method of claim 1, wherein the hard-to-dye fiber yarn is one or more than one selected from the group consisting of glass fiber yarn, polyethylene (PE) fiber yarn, polypropylene (PP) fiber yarn, ultra high molecular weight polyethylene (UHMWPE) fiber yarn, aramid fiber yarn, carbon fiber yarn, polyimide (PI) fiber yarn, polybenzoxazole (PBO) fiber yarn, and polybenzimidazole (FBI) fiber yarn.

3. The method of claim 1, wherein the dye among the ultraviolet ray hardening type coating liquid is an organic dye which has a resistance to discoloration from ultraviolet ray.

4. The method of claim 1, wherein the ultraviolet ray hardening type monomer among the ultraviolet ray hardening type coating liquid is one or more than one selected from the group consisting of methyl methacrylate, Isobonyl acrylate, Tetrahydrofurfuryl acrylate, 2-hydroxyethyl acrylate, 2-hydroxyethyl methacrylate, 2-hydroxyprophyl acrylate, n-butyl acrylate, Hexanediol diacrylate, Etoxy Etoxy ethylacrylate, and Octadecyl acrylate.

5. The method of claim 1, wherein the ultraviolet ray hardening type oligomer among the ultraviolet ray hardening type coating liquid is one or more than one oligomer selected from the group consisting of polyurethane acrylate, epoxy acrylate, unsaturated polyester acrylate, vinyl acrylate, polyvinyl butyral and polymethylmethacrylate.

6. The method of claim 1, wherein the photo initiator among the ultraviolet ray hardening coating liquid is one or more than one selected from the group consisting of benzophenone, Irgacure 184(1-Hydroxy-cyclohexyl-phenyl ketone), Irgacure 1173(2-Hydroxy-2-methyl-1-phenyl-1-propanone), Irgacure 907(2-methyl-1-[4-(methylthio)phenyl]-2-(4-mor-pholinyl)-1-propanone), and Darocure TPO(Diphenyl(2,4,6-trimethylbenzoyl)phosphine oxide).

7. The method of claim 1, wherein the ultraviolet ray irradiation is performed by a metal halide lamp which is formed by adding, to a mercury lamp, one or more than one selected from the group consisting of Fe, Ga and Mg, and an ultraviolet ray LED.

8. The method of claim 1, wherein an ultraviolet ray dry process is further added before and after the ultraviolet ray irradiation process.

9. The method of claim 1, wherein the thin film color coating method of the hard-to-dye fiber yarn is performed in the vertical direction from the ground from the coating liquid impregnation of the fiber yarn to the ultraviolet ray irradiation.
